(19) United States
(12) Patent Application Publication
(10) Pub. No.: US 2012/0311085 A1
(43) Pub. Date: Dec. 6, 2012

(54) METHOD AND SYSTEM FOR PROVISIONING CONTENT DISPLAY SYSTEMS USING MOBILE COMMUNICATIONS TECHNOLOGY

(75) Inventors: Scott Russell Francis, Danville, CA (US); Gregory Charles Herlein, San Francisco, CA (US); Alan Jay Stein, Princeton Junction, NJ (US)

(73) Assignee: THOMSON LICENSING

(21) Appl. No.: 13/578,772

(22) PCT Filed: Feb. 19, 2010
(86) PCT No.: PCT/US10/00481

§ 371 Date: Aug. 13, 2012

(51) Int. Cl. G06F 15/16

(52) U.S. Cl. 709/217

(57) ABSTRACT

A content display/digital signage system is provisioned using mobile communications technology by a method and system including a mobile communications device for collecting provisioning information from the content display system using a local communications channel and communicating the collected provisioning information to a server providing at least content to the content display system and a server for communicating data intended for the content display system to the mobile communications device. In one embodiment of the method and system of the present invention, the mobile communications device communicates the data intended for the content display system to the content display system using the local communications channel when the mobile device is once again in the proximity of the content display system.

### FIELD OF THE INVENTION

This invention relates to display systems and, more particularly, to a method for provisioning content display/digital signage applications using mobile communications technology.

### BACKGROUND OF THE INVENTION

Historically, content display/digital signage systems tended to focus on broadcast-like, one-way delivery of media content to remote systems. The delivery of media content in such system is typically accomplished using multicast/broadcast file transfer. In such system, remote endpoints may have valuable data stored in, for example, the log of display info, particularly as these termination points adopt advanced audience-measurement systems such as cameras and image analysis subsystems to determine the size and demographic profile of the audience.

However, due to network architectures, current systems may not efficiently facilitate backhaul and aggregation of this data. In addition, connectivity to such digital signage displays is often expensive, usually because a backhaul link to the infrastructure and management systems is cost-prohibitive.

### SUMMARY OF THE INVENTION

Embodiments of the present invention are directed at least in part to addressing the deficiencies of the prior art at least as described above by providing a method and system for provisioning a content display/digital signage system using mobile communications technology.

In one embodiment of the present invention, a method for provisioning a content display system includes collecting provisioning information from the content display system using a mobile communications device and a local communications channel, communicating the collected provisioning information from the mobile communications device to a server providing at least content to the content display system, communicating data intended for the content display system from the server to the mobile communications device and communicating the data intended for the content display system from the mobile communications device to the content display system using the local communications channel.

In an alternate embodiment of the present invention, a system for provisioning a content display system includes a mobile communications device for collecting provisioning information from the content display system using a local communications channel and communicating the collected provisioning information to a server providing at least content to said content display system and a server for communicating data intended for the content display system to the mobile communications device, where the mobile communications device communicates the data intended for the content display system to the content display system using the local communications channel when the mobile device is once again in the proximity of the content display system.

### BRIEF DESCRIPTION OF THE DRAWINGS

The teachings of the present invention can be readily understood by considering the following detailed description in conjunction with the accompanying drawings, in which:

FIG. 1 depicts a high level block of a mobile provisioning system in accordance with an embodiment of the present invention;

FIG. 2 depicts a high level block diagram of an in-store advertising network for providing in-store advertising of which the mobile provisioning system of FIG. 1 can be a part in accordance with an embodiment of the present invention; and

FIG. 3 depicts a flow diagram of a method for provisioning a content display system in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method and system for the provisioning of a content display/digital signage system using mobile device technology. Although the present invention will be described primarily within the context of a retail advertising network environment including a digital signage system being provisioned using a mobile phone having wireless communications, the specific embodiments of the present invention should not be treated as limiting the scope of the invention. It will be appreciated by those skilled in the art and informed by the teachings of the present invention that the concepts of the present invention can be advantageously applied in substantially any content distribution environment using different communication protocols via substantially any mobile communications device.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudo-code, and the like represent various processes which may be substantially represented in computer readable media and so executed by a computer or processor, whether or not such computer or processor is explicitly shown.

Although other techniques are contemplated for realizing the various embodiments of the present invention, it should be understood that an exemplary embodiment of the present invention is realized by using wireless communications. That is, most mobile communication devices, such as phones and PDAs, are wireless enabled and communicate on carrier networks for backhaul. An approach in accordance with various embodiments of the present invention is to provide asynchronous data transfer to and from the signage device without incurring any additional cost using, in one embodiment described herein, the wireless capabilities of mobile devices.

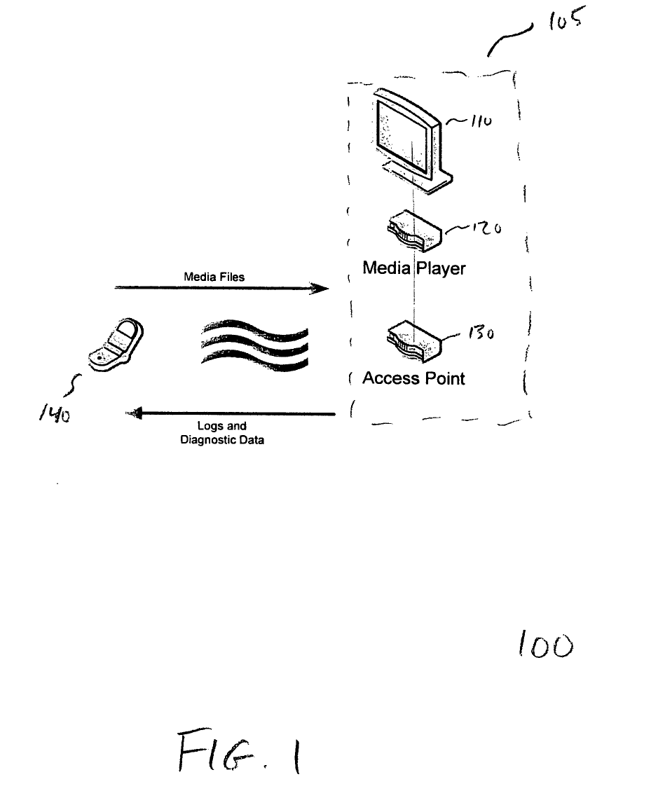

FIG. 1 depicts a high level block of a mobile provisioning system 100 in accordance with an embodiment of the present invention. The mobile provisioning system of FIG. 1 includes a digital signage system 105 including a display device 110, a media player 120 and an access device 130. The mobile provisioning system 100 of FIG. 1 further includes a mobile communications device, illustratively a mobile phone 140. The access device 130 of the digital signage system 105 receives, from an upstream source, data/content intended to be displayed on the display device 110 and played on the media player 120.

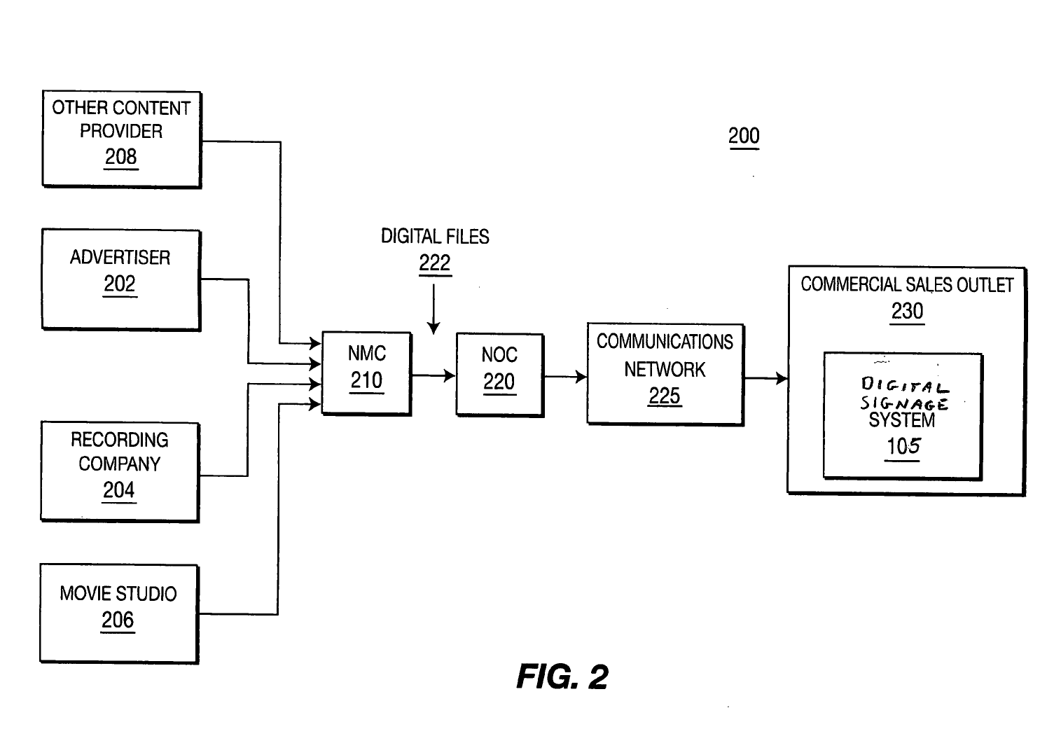

In one embodiment of the present invention, the digital signage system 105 of FIG. 1 can be a part of an in-store advertising network to which embodiments of the mobile provisioning system of the present invention can be applied. For example, FIG. 2 depicts a high level block diagram of an in-store advertising network 200 for providing in-store advertising. In the advertising network 200 of FIG. 2, the advertising network 200 and digital signage system 105 use a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the digital signage system 105 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the digital signage system 105 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry. The movie studio 206 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the digital signage system 105 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed.

The NOC 220 communicates digitized data files 222 to, in this example, the digital signage system 105 at a commercial sales outlet 230 via a communications network 225. The communications network 225 can be implemented in any one of several technologies. For example, in one embodiment of the present invention, a satellite link can be used to distribute digitized data files 222 to the digital signage system 105 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

Referring back to FIG. 1, illustratively, in the mobile provisioning system 100, the access device 130 of the digital signage system 105 comprises an integrated WiFi Access Point (AP) 130. In one embodiment of the present invention, an application is installed on the mobile phone 140, the installed application enabling the mobile phone 140 to communicate with the digital signage system 105, and in one embodiment, specifically the media player 120 via the WiFi Access Point 130. In one embodiment of the present invention, the installed application identifies the communication parameters of the digital signage system 105 such that the mobile phone 140 is able to communicate and transfer information to and from the appropriate components of the digital signage system 105.

The mobile phone 140 queries the digital signage system 105 to obtain metadata regarding the configuration and status of the digital signage system 105. In one embodiment, the digital signage system 105 responds to the query from the mobile phone 140 by providing its name, information about the location of the system, demographic information to define media affinity (i.e., the system is configured to play health and beauty related media or the system is configured to play media about entertainment or the system will not play media inappropriate for children) and other pertinent information.

In addition, in one embodiment of the present invention, the mobile device 140 determines if any data/media cached or stored in the mobile phone 140 is intended or appropriate for the location identified or reported by the digital signage system 105 in response to the query of the mobile phone 140. That is, and as will be described in further detail below, in various embodiments of the present invention, an upstream content source or server can communicate data/media intended for a digital signage system to which a mobile phone 140 has previously communicated, such that a next time the mobile phone 140 is in communication with a digital signage system for which the data/media is intended, the mobile phone 140 can communicate the data/content to the intended digital signage system.

As such, if the mobile phone 140 does have stored data intended for or appropriate for the identified location of the digital signage system 105, the mobile phone 140 transfers the data/media to the digital signage system 105, in one embodiment, via the WiFi Access Point 130. The mobile phone 140 can then, optionally, also collect play-log data and health diagnostic data from the digital signage system 105 and cache the information received from the digital signage system 105 for, in one embodiment, communication of that information to, for example, an upstream data/media source (explained further below).

Subsequently, when the mobile phone 140 is attached to a broadband connection it exchanges metadata about the digital signage system 105 with which the mobile phone 140 has previously communicated with, for example, an upstream data/media source which is capable of provisioning the digital signage system. This data includes, for example in one embodiment, the location id, the content that was on the signage, the content transferred to the signage, and the playlog and diagnostic health data that the signage sent to the mobile phone 140.

For example, in one embodiment of the present invention, when the mobile phone 140 is once again in a carrier coverage area of the mobile phone 140, the mobile phone 140 can send the accumulated metadata, content and/or data received from the digital signage system 105 to a central system server servicing the digital signage system 105.

For example, in one embodiment of the present invention, the mobile phone 140 can communicate any accumulated metadata, content and/or data received from the digital signage system 105 to the NMC 210 and/or the NOC 220 of the in-store advertising network 200 of FIG. 2 of which the digital signage system 105 is part. That is, in the embodiment of FIG. 2, the NMC 210 and/or the NOC 220 of the in-store advertising network 200 are sources of data/media to the digital signage system 105. In various embodiments of the present invention, such a communication can be accomplished using a peer-to-peer connection or through a direct network connection. As such, if the digital signage system 105 had experienced a critical problem (such as a failed component) as reported to the NMC 210 or NOC 220 by the mobile phone 140, the lost data could be transmitted to the operating environment of the digital signage system 105 on a priority basis to alert operators of the digital signage system 105 that there was a failure in that particular environment of the digital signage system 105.

As briefly described above, when in communication with the mobile phone 140, the central server can send data/media to the mobile phone 140 to be stored on the mobile phone 140 or in a memory accessible to the mobile phone (not shown) for later communication to the digital signage system 105. In various embodiments of the present invention, a decision to communicate or to not communicate data/media to a mobile phone for subsequent communication to an intended digital signage system can be based on historical information of the communication of the mobile phone 140. For example, if a particular mobile phone 140 illustrates a pattern of communicating with a particular digital signage system on a regular basis, for example each week for several weeks, then a central server might target that mobile phone as a potential path to deliver content/media intended for that digital signage system.

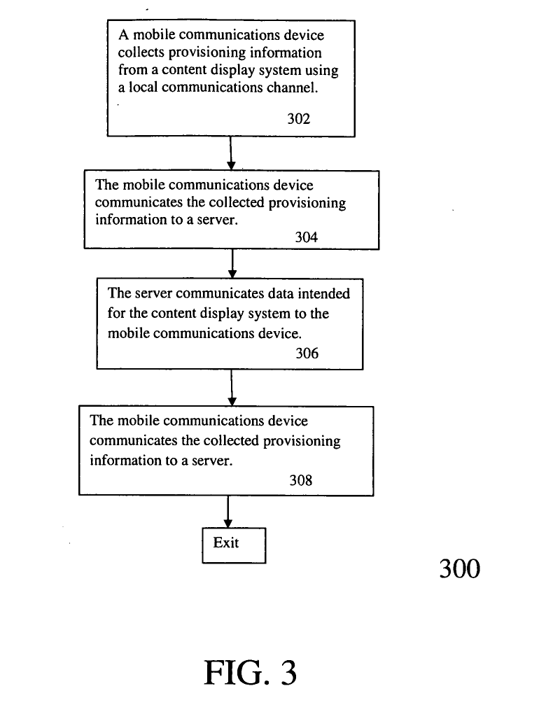

FIG. 3 depicts flow diagram of a method for provisioning a content display system in accordance with an embodiment of the present invention. The method 300 begins at step 302 at which a mobile communications device collects provisioning information from a content display system using a local communications channel. The method 300 then proceeds to step 304.

At step 304, the mobile communications device communicates the collected provisioning information to a server providing at least content to the content display system using, in one embodiment of the present invention, a broadband carrier channel. The method 300 then proceeds to step 306.

At step 306, a server communicates data intended for the content display system to the mobile communications device. The method 300 then proceeds to step 308.

At step 308, the mobile communications device communicates the data received from the server and intended for the content display system to the content display system using the local communications channel. The method 300 is then exited.

Over time and with sufficient mobile devices, the principles of the various embodiments of the present invention can be implemented to deliver data/media to digital signage systems as well as collect playlog and diagnostic health information from such systems for communication to, for example, a central server for causing the repair of any failures of the respective digital signage systems.

Having described various embodiments for a method and system for the provisioning of digital advertising/signage applications using mobile applications (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for provisioning a content display system, the method comprising:
collecting provisioning information from said content display system using a mobile communications device and a local communications channel;
communicating said collected provisioning information from said mobile communications device to a server providing at least content to said content display system;
communicating data intended for said content display system from said server to said mobile communications device; and
communicating said data received from said server and intended for said content display system to said content display system using said local communications channel.

2. The method of claim 1, wherein said local communications channel comprises a wireless communications channel.

3. The method of claim 2 wherein said wireless communications channel comprises a peer-to-peer communications channel.

4. The method of claim 1, wherein said local communications channel comprises a network connection.

5. The method of claim 1 wherein said provisioning information comprises at least one of identification information of the content display system, communication parameters of the content display system, information about a location of the content display system, demographic information relating to a location of the content display system, media affinity of the content display system, play-log data and health diagnostic data of the content display system.

6. The method of claim 1, wherein in response to negative health diagnostic information received from said mobile communications device, the server communicates to said content display system content missing at said content display system due to a failure.

7. The method of claim 1, wherein said mobile communications device and said server communicate over a broadband carrier channel.

8. The method of claim 1 wherein said data intended for said content display system comprises content lost due to a failure in the content display system.

9. A system for provisioning a content display system, comprising:
a mobile communications device for collecting provisioning information from said content display system using a local communications channel and communicating said collected provisioning information to a server providing at least content to said content display system; and
a server for communicating data intended for said content display system to said mobile communications device;
wherein said mobile communications device communicates said data intended for said content display system to said content display system using said local communications channel.

10. The system of claim 9 wherein said mobile communications device comprises a mobile phone having wireless communication capabilities.

11. The system of claim 9, wherein said content display system comprises a digital signage system.

12. The system of claim 9, wherein said server is a content source for said content display system.

13. The system of claim 9, wherein said mobile communications device comprises memory for storing received information and content.
